(19) United States
(12) Patent Application Publication
(10) Pub. No.: US 2026/0059374 A1
(43) Pub. Date: Feb. 26, 2026

(54) Efficient Hardware Filter Space Utilization for Data Connectivity

(71) Applicant: Apple Inc., Cupertino, CA (US)

(72) Inventors: Amit DUBEY, San Diego, CA (US); Rakshith SUNDARESHAN, San Diego, CA (US); Vijay VENKATARAMAN, San Jose, CA (US); Vivek G GUPTA, San Jose, CA (US)

(21) Appl. No.: 19/102,526

(22) PCT Filed: Aug. 10, 2023
(86) PCT No.: PCT/US2023/029944

§ 371 Date: Feb. 10, 2025

Related U.S. Application Data
(60) Provisional application No. 63/370,947, filed on Aug. 10, 2022.

(51) Int. Cl. H04W 28/02

(52) U.S. Cl. CPC H04W 28/0263; H04W 28/0205; H04W 28/0215; H04W 28/0268

(57) ABSTRACT

A user equipment (UE) configured to configure transceiver circuitry to transmit a packet data unit (PDU) session modification request message to a session management function (SMF), the PDU session modification request message comprising a maximum number of support packet filters information element (IE) for a PDU session established in N1 mode and decode, based on signals received from the SMF, a message in response to the PDU session modification request.

### PRIORITY/INCORPORATION BY REFERENCE

This application claims priority to U.S. Provisional Application Ser. No. 63/370,947 filed on Aug. 10, 2022, and entitled “Efficient Hardware Filter Space Utilization for Data Connectivity,” the entirety of which is incorporated herein by reference.

### BACKGROUND

A user equipment (UE) may be equipped with packet filters implemented in hardware. During operation, the packet filters may be allocated to one or more packet data unit (PDU) sessions. However, the hardware for packet filtering may have a fixed space limitation that cannot be increased at runtime. Thus, the number of hardware packet filters available for allocation may be fixed and limited. It has been identified that there is a need for techniques configured to enable the UE to dynamically manage hardware packet filter allocation.

### SUMMARY

Some exemplary embodiments are related to an apparatus of a user equipment (UE), the apparatus having processing circuitry configured to configure transceiver circuitry to transmit a packet data unit (PDU) session modification request message to a session management function (SMF), the PDU session modification request message comprising a maximum number of support packet filters information element (IE) for a PDU session established in N1 mode and decode, based on signals received from the SMF, a message in response to the PDU session modification request.

Other exemplary embodiments are related to a processor configured to configure transceiver circuitry to transmit a packet data unit (PDU) session modification request message to a session management function (SMF), the PDU session modification request message comprising a maximum number of support packet filters information element (IE) for a PDU session established in N1 mode and decode, based on signals received from the SMF, a message in response to the PDU session modification request.

Still further exemplary embodiments are related to an apparatus of a user equipment (UE), the apparatus having processing circuitry configured to determine that a preemption mechanism is to be utilized on a first packet data unit (PDU) session, wherein the preemption mechanism is configured to preempt PDU sessions from hardware packet filter space to software packet filter space and preempt the first PDU session to software packet filter space.

Additional exemplary embodiments are related to a processor configured to determine that a preemption mechanism is to be utilized on a first packet data unit (PDU) session, wherein the preemption mechanism is configured to preempt PDU sessions from hardware packet filter space to software packet filter space and preempt the first PDU session to software packet filter space.

Further exemplary embodiments are related to an apparatus of a user equipment (UE), the apparatus having processing circuitry configured to determine that a promotion mechanism is to be utilized on a first packet data unit (PDU) session, wherein the promotion mechanism is configured to promote PDU sessions from software packet filter space to hardware packet filter space and promote the first PDU session to software packet filter space.

Exemplary embodiments are also related to a processor configured to determine that a promotion mechanism is to be utilized on a first packet data unit (PDU) session, wherein the promotion mechanism is configured to promote PDU sessions from software packet filter space to hardware packet filter space and promote the first PDU session to software packet filter space.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows a signaling diagram for a packet data unit (PDU) session modification procedure according to various exemplary embodiments.

FIG. 4 shows a method for preemption detection according to various exemplary embodiments.

FIG. 5 shows a method for performing preemption according to various exemplary embodiments.

FIG. 6 shows a method for performing preemption according to various exemplary embodiments

FIG. 7 shows a signaling diagram for dynamic hardware packet management according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques for dynamically managing hardware packet filter allocation.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

In some of the examples provided below, the UE may be deployed within fifth generation (5G) New Radio (NR) network. However, reference to a 5G NR network is merely provided for illustrative purposes. The exemplary embodiments may be utilized with any appropriate type of network.

The exemplary embodiments are also described with regard to the UE being equipped with multiple packet filters. Throughout this description, the term “packet filter” generally refers to a hardware or software mechanism that is configured to map uplink traffic onto a dedicated quality of service (Qos) flow. The packet filters may operate at the non-access stratum (NAS) level and the QoS flow may be mapped in accordance with a Qos profile and QoS rules. Those skilled in the art will understand that a packet data unit (PDU) session may contain multiple QoS flows and the packet filters may be allocated to the PDU session for processing its Qos flows.

The exemplary embodiments are further described with regard to “fast filtering” and “slow filtering.” The term “fast filtering” refers to packet filtering being performed by one or more packet filters implemented in hardware. The hardware for packet filtering has a fixed space limitation that cannot be increased at run time. Thus, the number of hardware packet filters available for allocation may be fixed and limited. The term “slow filtering” refers to packet filtering being performed by one or more packet filters implemented in software. Typically, when compared to fast filtering, slow filtering takes more MIPS (Million instructions per second), consumes more power and has slower execution. Accordingly, it may be beneficial to allocate hardware packet filters to PDU sessions with higher priority levels and/or data rates.

In addition, the exemplary embodiments are described with regard to a maximum number of packet filters supported by the UE for a PDU session. Under conventional circumstances, once this parameter is indicated to the network by the UE during PDU session establishment or as part of PDU session modification during an inter-radio access technology (IRAT) transfer, the maximum number of packet filters supported by the UE for the PDU session cannot be changed during the lifetime of the PDU session. This is an inherently inefficient approach to hardware packet filter resource management because PDU session resource allocation and usage may be unknown to the UE when the maximum number of packet filters supported by the UE for the PDU session is indicated to the network. The static allocation of hardware packet filters may create a scenario where the limited number of packet filters are allocated to PDU sessions with a lower priority and/or data rate. For example, the UE may be configured with multiple PDU sessions. A first set of the multiple PDU sessions may be considered a high priority and/or have a high data rate while a second set of the multiple PDU session may be considered low priority and/or have a low data rate. Due to the static allocation of the fixed hardware packet filtering resources, a scenario may occur where a PDU sessions with lower priority and/or data rates has been allocated hardware packet filters while another PDU sessions with a higher priority and/or data rates has been allocated software packet filters. This type of scenario is not only an inefficient use of the UE's limited hardware packet filtering resources but may also lead to a detrimental user experience.

The exemplary embodiments introduce techniques for dynamically allocating hardware packet filter space. As will be demonstrated in detail below, the exemplary embodiments may provide the UE with the flexibility to control which PDU sessions are prioritized for hardware packet filter resource allocation. In addition, the exemplary embodiments introduce enhancements for PDU session modification procedures that may enable the UE to dynamically allocate the hardware packet filters. Each of these exemplary embodiments will be described in more detail below. The exemplary enhancements and techniques introduced herein may be used independently from one another, in conjunction with other currently implemented hardware packet filter management techniques, future implementations of hardware packet filter management techniques or independently from other hardware packet filter management techniques.

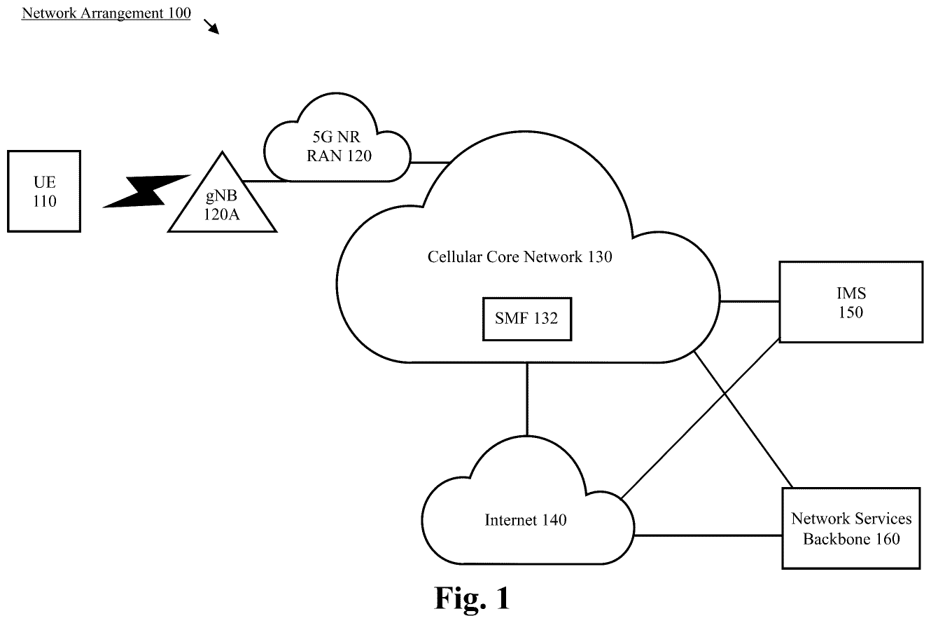

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., a sixth generation (6G) RAN, a 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130. The cellular core network 130 may generally refer to an interconnected set of components that manages the operation and traffic of the cellular network. It may include the evolved packet system (EPS), the 5G core (5GC) and/or any other appropriate type of system. The cellular core network 130 also manages the traffic that flows between the cellular network and the Internet 140.

The cellular core network 130 may comprise various different types of functions, each configured to perform a variety of different tasks. In the network arrangement 100, the cellular core network 130 is shown to include a session management function (SMF) 132. The SMF 210 may perform operations related to session management such as, but not limited to, session establishment, session release, IP address allocation, policy and QoS enforcement, etc. In the examples provided below, the UE 110 and the SMF 132 may participate in a signaling exchange for PDU session establishment and PDU session modification. The exemplary embodiments are not limited to an SMF that performs the above referenced operations. Those skilled in the art will understand the variety of different types of operations a SMF may perform. Further, reference to a single SMF 132 is merely for illustrative purposes, an actual network arrangement may include any appropriate number of SMFs.

In addition, the network arrangement 100 may further an IP Multimedia Subsystem (IMS) 150 and a network services backbone 160. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

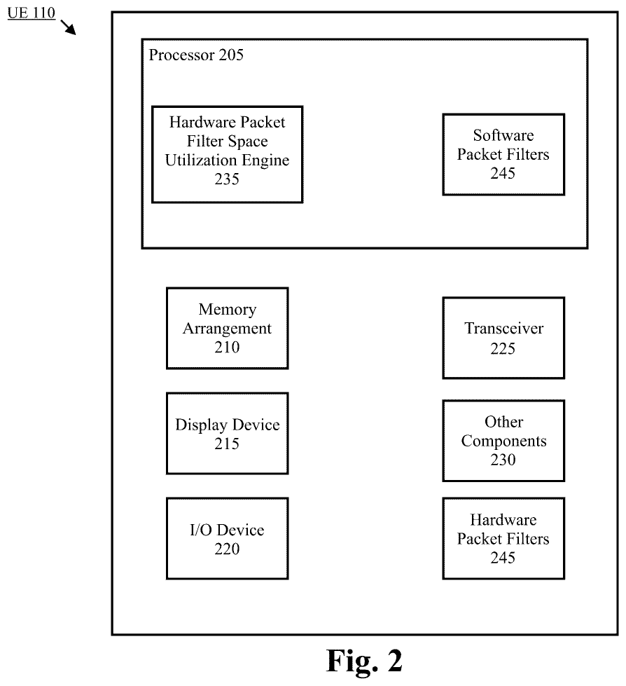

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225, other components 230 and hardware packet filters 245. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a hardware packet filter space utilization engine 235. The hardware packet filter space utilization engine 235 may perform various operations related to dynamically allocating hardware packet filter space to PDU sessions.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The processor 205 may also execute one or more packet filters implemented in software, e.g., software packet filters 240. The filter space for the software packet filters 240 may be configured to perform packet filtering operations for QoS flows. The filter space for the software packet filters 240 may be assigned from dynamic memory. Thus, the number of software packet filters may be increased and decreased during runtime.

The hardware packet filters 245 represent one or more hardware components configured to perform packet filtering operations for QoS flows. The hardware packet filters 245 may be implemented as a separate incorporated component of the UE 110 or may be a modular component coupled to the UE 110, e.g., an integrated circuit with or without firmware. For example, the integrated circuit may include input circuitry to receive signals and processing circuitry to process the signals and other information.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), a 6G RAN, etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

According to some aspects, the exemplary embodiments introduce enhancements for PDU session modification that may enable the UE 110 to dynamically manage hardware packet filter space. As will be described in more detail below, the UE 110 may perform PDU session modification to increase or decrease the number of packet filters supported by the UE 110 for a particular PDU session. Various exemplary embodiments related to the manner in which the UE 110 may trigger PDU session modification and dynamically manage hardware filter hardware filter space are described in detail below after the description of the exemplary enhancements for PDU session modification.

Some of the examples provided below are described with regard to N1 mode and S1 mode. Those skilled in the art will understand that the term “N1 mode” refers to an operating mode during which the UE 110 may access the 5GC via a 5G access network (e.g., NR, E-UTRA, etc.) and the term “S1 mode” refers to an operating mode during which the UE 110 may access the EPS via an LTE access network (e.g., E-UTRA). Throughout this description, these terms are being used in the manner in which they are defined in various 3GPP Specifications. In addition, while various examples are described with regard to creating a PDU session in S1 or N1 mode, the exemplary embodiments are not limited to these modes and may be applied to a PDU session created in any particular mode.

During operation, the UE 110 may indicate the maximum number of packet filters it can support for a packet data network (PDN) connection created in S1 mode after an inter-system change to N1 mode using the PDU SESSION MODIFICATION REQUEST message. However, after the first IRAT transfer (e.g., S1 mode to N1 mode, etc.) the UE 110 may be unable to update the maximum number of packet filters that it can support after the transfer. In addition, for a PDU session created in N1 mode, the UE 110 may be unable to update the maximum number of packet filters that it can support after the PDU session is created. It has been identified that it may be beneficial to allow the UE 110 to update the maximum number of packet filters it can support as part of a PDU session modification procedure. For instance, mechanisms like reflective QoS may dynamically add packet filters to a QoS flow and thus, the maximum number of packet filters supported by the UE 110 for the PDU session may need to change dynamically. The exemplary embodiments introduce enhancements to PDU session modification that enable the UE 110 to change its maximum number of packet filters supported for the PDU session

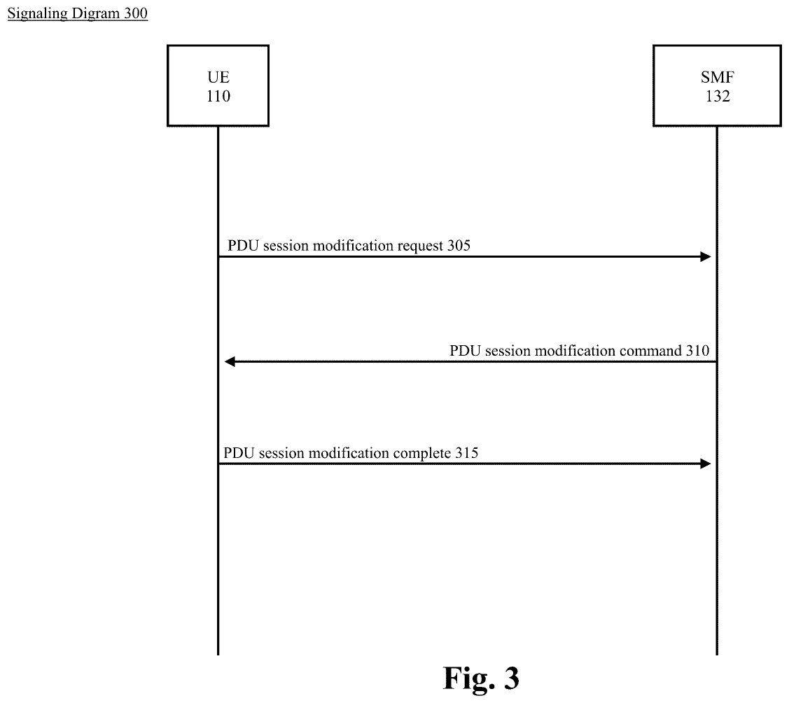

FIG. 3 shows a signaling diagram 300 for a PDU session modification procedure according to various exemplary embodiments. The signaling diagram 300 includes the UE 110 and the SMF 132 of the network arrangement 100.

Initially, consider a scenario in which the UE 110 is equipped with a hardware filter space which comprises a maximum number of hardware filters. During operation, the UE 110 may allocate hardware packet filters or software packet filters to a PDU session. When dynamically managing the hardware packet filter space, for any of a variety of different reasons, the UE 110 may decide to increase or decrease the number of packet filters supported by the UE 110 for a particular PDU session. While it may be beneficial to utilize the exemplary enhancements for PDU session modification described with regard to the signaling diagram 300 in conjunction with exemplary embodiments for dynamically managing hardware filter space described after the signaling diagram 300, these exemplary embodiments are not required to be utilized together. The exemplary enhancements for PDU session modification may be applied to a PDU session modification procedure triggered by the UE 110 for any appropriate purpose.

In 305, the UE 110 transmits a PDU SESSION MODIFICATION REQUEST to the SMF 132. For example, the UE 110 may be triggered to transmit this request to increase a maximum number of packet filters supported by the UE 110 for a PDU session or decrease the maximum number of packet filters supported by the UE 110 for a PDU session.

Accordioning to some aspects, if the UE 110 is performing the PDU session modification procedure to indicate the maximum number of packet filters that can be supported by the PDU session type (e.g., IPv4 session type, IPv6 session type, IPv4v6 session type, ethernet session type, any other appropriate PDU Session type) and the UE 110 can support more than a predetermined threshold number of packet filters for the PDU session (e.g., 0, 1, 10, 16, 40, 50, etc.) , the UE 110 may indicate the maximum number of packet filters supported by the UE 110 for the PDU session in a maximum number of supported packet filters information element (IE) of the PDU SESSION MODIFICATION REQUEST message.

In some embodiments, the maximum number of supported packet filters IE may be included a PDU SESSION MODIFICATION REQUEST for a PDN connection established when in S1 mode, after an inter-system change from S1 mode to N1 mode, if the UE 110 has or has not previously successfully performed the UE requested PDU session modification procedure to provide this capability. In other embodiments, the maximum number of supported packet filters IE may be included a PDU session established in N1 mode.

In 310, the SMF 132 transmits a PDU SESSION MODIFICATION COMMAND to the UE 110. In this example, it is assumed that the request is accepted by the network. However, in an actual deployment scenario, the SMF 132 may transmit a PDU SESSION MODIFICATION REJECT message to the UE 110 in response to the PDU SESSION MODIFICATION REQUEST if the request is denied for any of a variety of different reasons.

The signals 310-315 of the signaling diagram 300 may be considered part of a network-requested PDU session modification procedure. According to some aspects, if the network requested PDU session modification procedure is triggered by a UE requested PDU session modification (e.g., 305-315) for a PDU session established in N1 mode or a PDN connection established in S1 mode upon an inter-system change from S1 mode to N1 mode, and the PDU SESSION MODIFICATION REQUEST includes the maximum number of supported packet filters IE, the SMF 132 may consider the indicated maximum number of packet filters supported by the UE 110 for the PDU session as the maximum number of packet filters supported by the UE 110 for the PDU session. Otherwise, the SMF 132 may assume that the UE 110 supports a predetermined number of packet filters for this PDU session (e.g., 1, 16, 40, 50, etc.).

In 315, the UE 110 transmits a PDU session modification complete command to the SMF 132. In this example, it is assumed that the command is accepted by the UE 110. However, in an actual deployment scenario, the UE 110 may transmit a PDU SESSION MODIFICATION REJECT message to the SMF 132 in response to the PDU SESSION MODIFICATION COMMAND message if the command is denied for any of a variety of different reasons.

According to other aspects, the exemplary embodiments introduce techniques for dynamically managing the hardware packet filter space of the UE 110. The exemplary embodiments described below include preemption detection, promotion detection and promotion. Generally, preemption relates to moving a PDU session from hardware packet filter space into a software packet filter space and promotion relates to moving a PDU session from a software packet filter space to a hardware packet filter space. These mechanisms may allow the UE 110 to dynamically allocate its hardware filter space to PDU sessions based on their priority, relevant user actions and/or any other appropriate parameter such that an adequate user experience is achieved (e.g., adequate data rates, sufficient QoS parameters, little to no jitter, minimal latency, etc.)

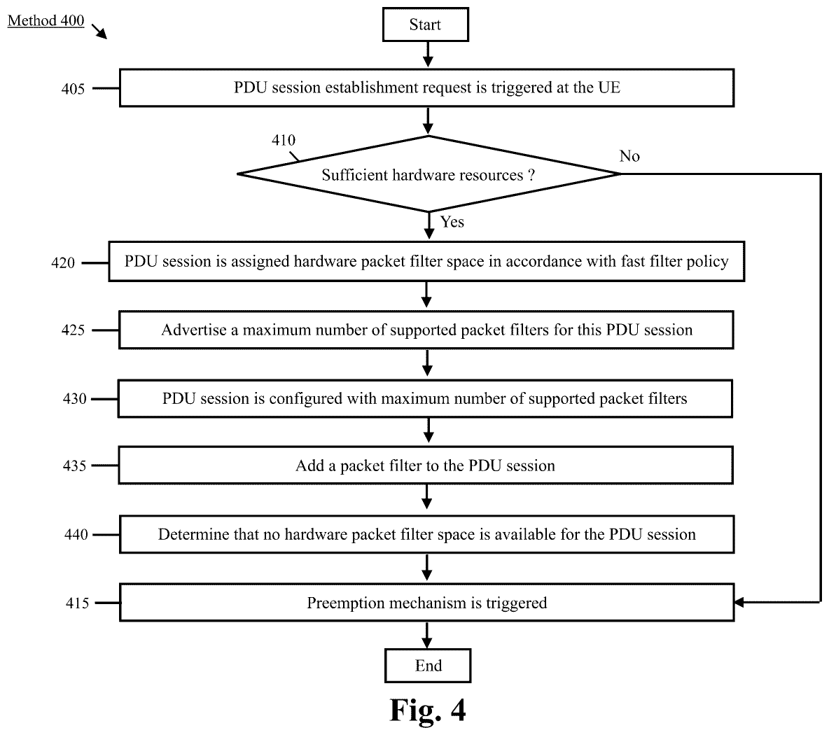

FIG. 4 shows a method 400 for preemption detection according to various exemplary embodiments. The method 400 is described from the perspective of the UE 110 of the network arrangement 100.

The method 400 provides a general overview of how the UE 110 may decide when a PDU session that is allocated hardware packet filter space is to be moved to software packet filter space. In 405, a PDU session establishment request is triggered at the UE 110. For example, an application running on the UE 110 may be launched or a type of service may be initiated at the UE 110.

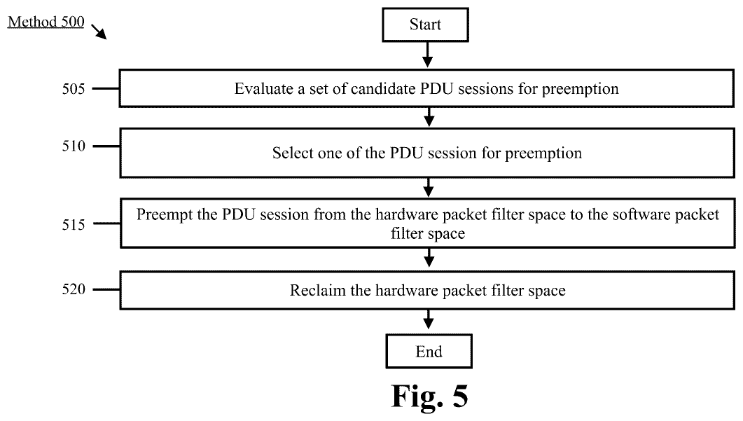

In 410, the UE 110 determines whether there are sufficient hardware packet filter resources to accommodate the PDU session. If there are insufficient hardware packet filter resources, the method 400 may continue to 415 where a preemption mechanism is triggered. As will be described in more detail below with regard to the method 500 of FIG. 5, the preemption mechanism may determine which PDU session of the UE 110 is to be preempted from the hardware packet filter space to the software packet filter space.

Returning to 410, if the UE 110 determines that there are sufficient hardware packet filter resources to accommodate the PDU session, the method 400 continues to 420. In 420, the PDU session is assigned hardware filter space in accordance with a fast filter policy. The fast filter policy may comprise various rules that provide the basis for how hardware filter space is allocated. In this example, in accordance with the fast filter policy, every PDU session is initially treated equally and may be granted hardware filtering space, the filter space may be based on a total remaining filter space and existing PDU session may be preempted upon insufficient hardware filtering space. However, the exemplary embodiments are not limited to these rules and may be applied to a hardware filter space policy comprising any appropriate number of rules.

In 425, the UE 110 advertises a maximum number of supported packet filters for this PDU session. The maximum number of supported packet filters may be the number of hardware packet filters assigned to the PDU session in accordance with the hardware packet filter policy. This parameter may be indicated to the network in an IE provided during PDU session establishment or PDU session modification.

In 430, the PDU session is configured with the maximum number of supported packet filters. In 435, the UE 110 may be triggered to add a packet filter to the PDU session. However, the PDU session is already configured with the maximum number of supported packet filters. For example, the UE 110 may receive a downlink signal and due to reflective QoS be triggered to add a packet filter to the PDU session. Those skilled in the art will understand that reflective QoS enables packet filters to be dynamically added and removed without NAS signaling. In another example, the UE 110 may receive a network assigned NAS signaled Qos packet filter for the PDU session. However, these examples are merely provided for illustrative purposes. The UE 110 may be triggered to add a packet filter to a PDU session for any appropriate reason.

In 440, the UE 110 determines that there is no hardware filter packet space available for the additional packet filter. Accordingly, there are insufficient hardware packet filter resources and thus, in 415, the preemption mechanism is triggered.

FIG. 5 shows a method 500 for performing preemption according to various exemplary embodiments. The method 500 is described from the perspective of the UE 110 of the network arrangement 100.

In 505, the UE 110 evaluates a set of candidate PDU sessions for preemption. For example, the UE 110 may utilize a two pass algorithm to preempt PDU sessions from hardware filter space into software filter space. A first pass may comprise selecting a PDU session with a lowest data rate from a set of candidates PDU sessions. In this example, the PDU sessions may be assigned a high data rate or a low data rate based on configured throughout by the network, actual throughout (e.g., bytes sent/received by the UE 110, etc.) , GBR/MBR (Guaranteed Bit Rate/Maximum Bit Rate), non-internet PDN, any combination thereof and/or any other appropriate condition may be considered. However, if multiple PDU sessions have a lowest data rate data rate or any other appropriate another condition is present, the second pass of the algorithm may be utilized. The second pass may comprise selecting a PDU session with a lowest packet filter rule hit count. For example, the number of times a hardware packet filter has matched uplink data packets to a QoS flow for a PDU session may be counted. The PDU session with the lowest packet filter rule hit count may be selected. However, the exemplary embodiments are not limited to this criteria and any appropriate condition may be utilized to select a PDU session for preemption.

In 510, the UE 110 selects one of the PDU sessions for preemption. In 515, the UE 110 preempts the PDU session from the hardware packet filter space to the software packet filter space. In 520, the UE 110 reclaims the hardware filter space. Those skilled in the art will understand the types of operations that may be performed to reclaim hardware space.

In some embodiments, after the method 500, the UE 110 may initiate PDU session modification. To provide an example, within the context of the method 400, the UE 110 may be triggered to add a hardware packet filter to a first PDU session that has already been allocated its maximum number of hardware packet filters and there is no hardware filter space available to accommodate the first PDU session, the UE 110 may utilize the method 500 to select a second different PDU session for preemption. Moving the second PDU session may provide the hardware filter space needed to accommodate the first PDU session. Thus, the UE 110 may perform PDU session modification to add the now available hardware packet filters to the first PDU session.

In another example, after the method 500, the UE 110 may initiate PDU session establishment. To provide an example, within the context of the method 400, the UE 110 may determine that there is not enough hardware packet filter space for a first PDU session that is to be established by the UE 110. The UE 110 may then utilize the method 500 to select a second different PDU session for preemption. Moving the second PDU session may provide the hardware filter space needed to accommodate the first PDU session. Thus, the UE 110 may initiate PDU session establishment to add the now available hardware packet filters to the first PDU session.

The UE 110 may also be configured to perform promotion detection and utilize a promotion mechanism. The UE 110 may execute both preemption and promotion operations simultaneously to dynamically manage the hardware packet filter space. However, the exemplary embodiments described herein may be used independently from one another, in conjunction with other currently implemented hardware packet filter management techniques, future implementations of hardware packet filter management techniques or independently from other hardware packet filter management techniques.

During operation, the UE 110 may monitor for various different types of events and/or conditions indicating that hardware packet filter space associated with one or more packet filters may be reclaimed. For example, QoS filters associated with a PDU session may be deleted by the network (e.g., reflective QoS, etc.) or a PDU session may be released. In response, the UE 110 may reclaim hardware filter space that was previously allocated to the PDU session. In addition, the UE 110 may initiate PDU session modification to decrease the maximum number of packet filters supported by the UE 110 for the PDU session.

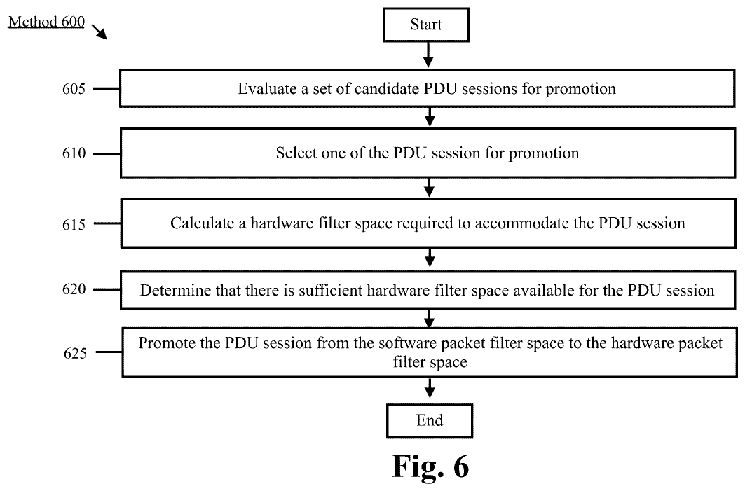

FIG. 6 shows a method 600 for performing preemption according to various exemplary embodiments. The method 600 is described from the perspective of the UE 110 of the network arrangement 100.

In 605, the UE 110 evaluates a set of candidate PDU sessions for promotion. For example, the UE 110 may utilize a two pass algorithm to promote PDU sessions from software filter space into hardware filter space. A first pass may comprise Selecting a PDU session with a highest data rate from a set of candidates PDU sessions. In this example, the PDU sessions may be assigned a high data rate or a low data rate based on configured throughout by the network, actual throughout (e.g., bytes sent/received by the UE 110, etc.), GBR/MBR, non-internet PDN, any combination thereof and/or any other appropriate condition may be considered. However, if multiple PDU sessions have a highest data rate data rate or any other appropriate another condition is present, the second pass of the algorithm may be utilized. The second pass may comprise selecting a PDU session with a highest packet filter rule hit count. For example, the number of times a hardware packet filter has matched uplink data packets to a QoS flow for a PDU session may be counted. The PDU session with the highest packet filter rule hit count may be selected. However, the exemplary embodiments are not limited to this criterion and any appropriate condition may be utilized to select a PDU session for promotion.

In 610, the UE 110 selects one of the PDU sessions for promotion. In some embodiments, promotion may only be allowed when sufficient space is available for the PDU session. Accordingly, in 615, the UE 110 may calculate a hardware filter space required to accommodate the selected PDU session. In 620, the UE 110 determines that there are sufficient hardware packet filter resources. However, in other examples, the UE 110 may determine that there is not sufficient hardware packet filter space available. In response the UE 110 may abandon promotion operations until a subsequent condition occurs, select a different PDU session for promotion and/or trigger preemption operations.

In 625, the UE 110 promotes the PDU session from the software packet filter space to the hardware packet filter space. For example, the UE 110 may assign hardware filter space to the PDU session. Those skilled in the art will understand the types of operations that may be performed to reclaim hardware space.

The exemplary preemption and promotion mechanisms described above may enable the UE 110 to dynamically manage the hardware resource allocation based on any appropriate conditions (e.g., PDU session priority, data rates, etc.) when a new PDU session is established and/or when a PDU session modification is triggered to add or remove filters from the PDU session. This provides the UE 110 with flexibility to control which PDUs are prioritized for hardware resources without sacrificing user experience.

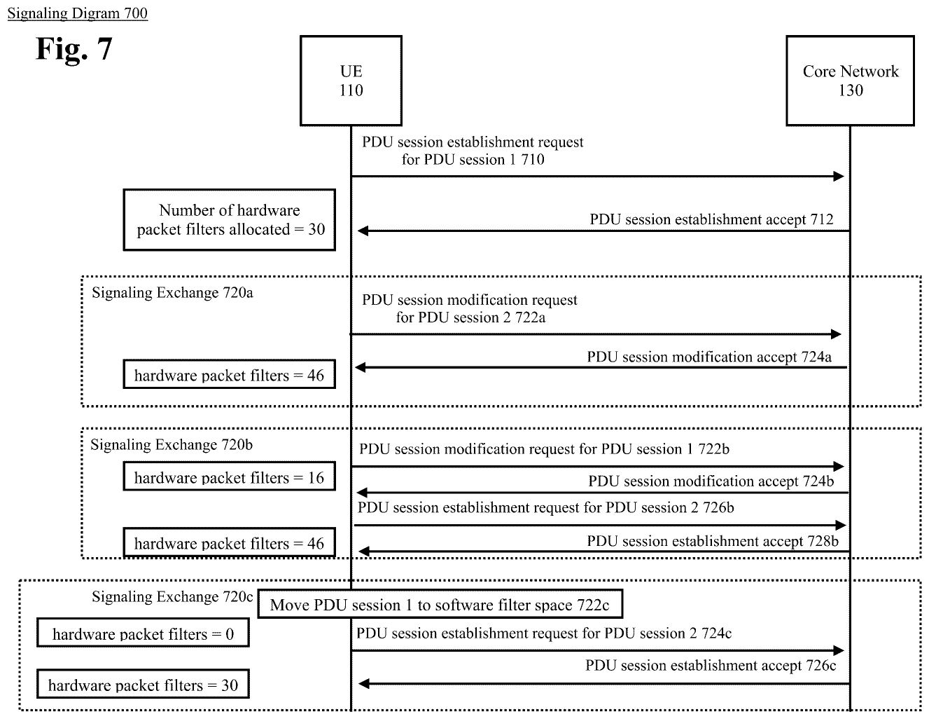

FIG. 7 shows a signaling diagram 700 for dynamic hardware packet management according to various exemplary embodiments. The signaling diagram 700 provides a general overview of how the exemplary embodiments may be utilized in conjunction with one another. Initially, consider a scenario in which the UE 110 is configured with a maximum of 50 hardware packet filters.

The signaling diagram 700 includes the UE 110 and the core network 130 (e.g., 5GC) of the network arrangement 100. In 710, the UE 110 may send a PDU session establishment request for PDU session 1. The PDU session establishment request may indicate a maximum number of supported packet filters for PDU session 1 is set to 30. In 712, the core network 130 may send the UE 110 a PDU session establishment accept message. At this time, the current number of hardware packet filters being utilized is 30.

In signaling exchange 720a, the UE 110 may send a PDU session establishment request 722a for PDU session 2. The PDU session establishment request 722a may indicate a maximum number of supported packet filters for PDU session 2 is set to 16. In 724a, the core network 130 may send the UE 110 a PDU session establishment accept message. At this time, the current number of hardware packet filters being utilized is 46 (e.g., PDU session 1=30, PDU session 2=16).

Alternative to signaling exchange 720a, in signaling exchange 720b, the UE 110 transmit PDU SESSION MODIFICATION REQUEST 722b to indicate a maximum number of supported packet filters for PDU session 1 is changed to 16. In 724b, the core network 130 may send the UE 110 a PDU session modification accept message. At this time, the current number of hardware packet filters being utilized is 16 (e.g., PDU session 1=16).

In 726b of the signaling exchange 720b, the UE 110 may send a PDU session establishment request for PDU session 2. The PDU session establishment request 726b may indicate a maximum number of supported packet filters for PDU session 2 is set to 30. In 728b, the core network 130 may send the UE 110 a PDU session establishment accept message. At this time, the current number of hardware packet filters being utilized is 46 (e.g., PDU session 1=16, PDU session 2=30).

Alternative to signaling exchanges 720a and 720b, in 722c of the signaling exchange 720c, the UE 110 may move PDU session 1 from the hardware packet filter space to the software packet filter space. At this time, the current number of hardware packet filters being utilized is 0.

In 724c, the UE 110 may send a PDU session establishment request for PDU session 2. The PDU session establishment request may indicate a maximum number of supported packet filters for PDU session 2 is set to 30. In 726c, the core network 130 may send the UE 110 a PDU session establishment accept message. At this time, the current number of hardware packet filters being utilized is 30 (e.g., PDU session 1=0, PDU session 2=30).

### Examples

In a first example, a method performed by a user equipment (UE), comprising transmitting a packet data unit (PDU) session modification request message to a session management function (SMF), the PDU session modification request message comprising a maximum number of support packet filters information element (IE) for a PDU session established in N1 mode and receiving a message from the SMF in response to the PDU session modification request.
In a second example, the method of the first example, wherein the message from the SMF is a PDU session modification command.
In a third example, the method of the first example, wherein the PDU session is a PDU session type of IPv4, IPv6, IPv4v6, or ethernet.
In a fourth example, the method of the first example, wherein the maximum number of supported packet filters IE indicates to the SMF a maximum number of packet filters that can be supported by the UE for the PDU session.
In a fifth example, a processor configured to perform any of the methods of the first through fourth examples.
In a sixth example, a user equipment (UE) comprising a transceiver configured to communicate with a network and a processor communicatively coupled to the transceiver and configured to perform any of the methods of the first through fourth examples.
In a seventh example, a method performed by a session management function (SMF), comprising receiving a packet data unit (PDU) session modification request message from a user equipment (UE), the PDU session modification request message comprising a maximum number of support packet filters information element (IE) for a PDU session established in N1 mode and transmitting a message to the UE in response to the PDU session modification request.
In an eighth example, the method of the seventh example, wherein the message is a PDU session modification command.
In a ninth example, the method of the seventh example, wherein the PDU session is a PDU session type of IPv4, IPv6, IPv4v6, or ethernet.
In a tenth example, the method of the seventh example, wherein the maximum number of support packet filters IE indicates to the SMF a maximum number of packet filters that can be supported by the UE for the PDU session.
In an eleventh example, one or more processors configured to perform any of the methods of the seventh through tenth examples.
In a twelfth example, a method performed by a user equipment (UE), comprising determining that a preemption mechanism is to be utilized on a first packet data unit (PDU) session, wherein the preemption mechanism is configured to preempt PDU sessions from hardware packet filter space to software packet filter space and preempting the first PDU session to software packet filter space.
In a thirteenth example, the method of the twelfth example, wherein determining that the preemption mechanism is to be utilized on the first PDU session is based on determining that there is insufficient hardware packet filter space for a new PDU session.
In a fourteenth example, the method of the twelfth example, wherein each new PDU session is assigned hardware packet filter space.
In a fifteenth example, the method of the twelfth example, further comprising assigning hardware packet filter space to a second PDU session.
In a sixteenth example, the method of the fifteenth example, further comprising advertising a maximum number of allowed packet filters for the second PDU Session.
In a seventeenth example, the method of the sixteenth example, wherein determining that the preemption mechanism is to be utilized on the first PDU session is based on determining that the second PDU session has reached the maximum number of allowed packet filters, additional packet filters are needed for the second PDU session and there is insufficient hardware packet filter space to accommodate the second PDU session.
In an eighteenth example, the method of the Seventeenth example, wherein determining that additional packet filters space is needed for the second PDU session is based on reflective quality of service (Qos).
In a nineteenth example, the method of the seventeenth example, wherein determining that additional packet filters are needed for the second PDU session is based on network assigned non-access stratum (NAS) signaled quality of service (QoS) packet filters.
In a twentieth example, the method of the twelfth example, wherein the first PDU session is selected from a set of PDU sessions based on a data rate associated with each PDU session in the set of PDU sessions and wherein the first PDU session has the lowest data rate from the set of PDU sessions.
In a twenty first example, the method of the twelfth example, wherein the first PDU session is selected from a set of PDU sessions based on a packet filter rule hit count associated with each PDU session in the set of PDU sessions and wherein the first PDU session has the lowest packet filter rule hit count from the set of PDU sessions.
In a twenty second example, the method of the twelfth example, further comprising reclaiming, after preempting the first PDU session, hardware packet filter space previously allocated to the first PDU session.
In a twenty third example, the method of the twelfth example, further comprising transmitting, after preempting the first PDU session, a PDU session modification request for a second PDU session to increase a maximum number of supported packet filters for the second PDU session.
In a twenty fourth example, the method of the twelfth example, further comprising transmitting, after preempting the first PDU session, a PDU establishment modification request for a second PDU session.
In a twenty fifth example, a processor configured to perform any of the methods of the twelfth through twenty fourth examples.
In a twenty sixth example, a user equipment (UE) comprising a transceiver configured to communicate with a network and a processor communicatively coupled to the transceiver and configured to perform any of the methods of the twelfth through twenty fourth examples.
In a twenty seventh example, a method performed by a user equipment (UE), comprising determining that a promotion mechanism is to be utilized on a first packet data unit (PDU) session, wherein the promotion mechanism is configured to promote PDU sessions from software packet filter space to hardware packet filter space and promoting the first PDU session to software packet filter space.
In a twenty eighth example, the method of the twenty seventh example, wherein determining that a promotion mechanism is to be utilized on the first PDU session is based on identifying that quality of service (Qos) packet filters have been deleted.
In a twenty ninth example, the method of the twenty seventh example, wherein determining that a promotion mechanism is to be utilized on the first PDU session is based on identifying that a second PDU session has been released.
In a thirtieth example, the method of the twenty seventh example, further comprising transmitting a PDU session modification request to decrease a maximum number of packet filters supported by a second PDU session.
In a thirty first example, the method of the twenty seventh example, wherein the first PDU session is selected from a set of PDU sessions for promotion based on a data rate associated with each PDU session in the set of PDU sessions and wherein the first PDU session has the highest data rate from the set of PDU sessions.
In a thirty second example, the method of the twenty seventh example, wherein the first PDU session is selected from a set of PDU sessions for promotion based on a packet filter rule hit count associated with each PDU session in the set of PDU sessions and wherein the first PDU session has the highest packet filter rule hit count from the set of PDU sessions.
In a thirty third, a processor configured to perform any of the methods of the twenty seventh through thirty second examples.
In a thirty fourth example, a user equipment (UE) comprising a transceiver configured to communicate with a network and a processor communicatively coupled to the transceiver and configured to perform any of the methods of the twenty seventh through thirty second examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
configure transceiver circuitry to transmit a packet data unit (PDU) session modification request message to a session management function (SMF), the PDU session modification request message comprising a maximum number of support packet filters information element (IE) for a PDU session established in N1 mode; and
decode, based on signals received from the SMF, a message in response to the PDU session modification request.

2. The apparatus of claim 1, wherein the message from the SMF is a PDU session modification command.

3. The apparatus of claim 1, wherein the PDU session is a PDU session type of IPv4, IPv6, IPv4v6, or ethernet.

4. The apparatus of claim 1, wherein the maximum number of supported packet filters IE indicates to the SMF a maximum number of packet filters that can be supported by the UE for the PDU session.

5. An apparatus of a user equipment (UE), the apparatus comprising processing circuitry configured to:
determine that a preemption mechanism is to be utilized on a first packet data unit (PDU) session, wherein the preemption mechanism is configured to preempt PDU sessions from hardware packet filter space to software packet filter space; and
preempt the first PDU session to software packet filter space.

6. The apparatus of claim 5, wherein the processing circuitry determines that the preemption mechanism is to be utilized on the first PDU session based on determining that there is insufficient hardware packet filter space for a new PDU session.

7. The apparatus of claim 5, wherein the processing circuitry is further configured to:
assign hardware packet filter space to a second PDU Session.

8. The apparatus of claim 7, wherein the processing circuitry is further configured to:
advertise a maximum number of allowed packet filters for the second PDU Session.

9. The apparatus of claim 8, wherein the processing circuitry determines that the preemption mechanism is to be utilized on the first PDU session based on determining that the second PDU session has reached the maximum number of allowed packet filters, additional packet filters are needed for the second PDU session and there is insufficient hardware packet filter space to accommodate the second PDU session.

10. The apparatus of claim 9, wherein the processing circuitry determines that additional packet filters space is needed for the second PDU session based on reflective quality of service (QoS).

11. The apparatus of claim 9, wherein the processing circuitry determines that additional packet filters are needed for the second PDU session based on network assigned non-access stratum (NAS) signaled quality of service (Qos) packet filters.

12. The apparatus of claim 5, wherein the first PDU session is selected from a set of PDU sessions based on a data rate associated with each PDU session in the set of PDU sessions and wherein the first PDU session has the lowest data rate from the set of PDU sessions.

13. The apparatus of claim 5, wherein the first PDU session is selected from a set of PDU sessions based on a packet filter rule hit count associated with each PDU session in the set of PDU sessions and wherein the first PDU session has the lowest packet filter rule hit count from the set of PDU sessions.

14. The apparatus of claim 5, wherein the processing circuitry is further configured to:
reclaim, after preempting the first PDU session, hardware packet filter space previously allocated to the first PDU session.

15. The apparatus of claim 5, wherein the processing circuitry is further configured to:
configure transceiver circuitry to transmit, after preempting the first PDU session, a PDU session modification request for a second PDU session to increase a maximum number of supported packet filters for the second PDU session.

16. An apparatus of a user equipment (UE), the apparatus comprising processing circuitry configured to:
determine that a promotion mechanism is to be utilized on a first packet data unit (PDU) session, wherein the promotion mechanism is configured to promote PDU sessions from software packet filter space to hardware packet filter space; and
promote the first PDU session to software packet filter space.

17. The apparatus of claim 16, wherein determining that a promotion mechanism is to be utilized on the first PDU session is based on identifying that quality of service (Qos) packet filters have been deleted.

18. The apparatus of claim 16, wherein determining that a promotion mechanism is to be utilized on the first PDU session is based on identifying that a second PDU session has been released.

19. The apparatus of claim 16, wherein the first PDU session is selected from a set of PDU sessions for promotion based on a data rate associated with each PDU session in the set of PDU sessions and wherein the first PDU session has the highest data rate from the set of PDU sessions.

20. The apparatus of claim 16, wherein the first PDU session is selected from a set of PDU sessions for promotion based on a packet filter rule hit count associated with each PDU session in the set of PDU sessions and wherein the first PDU session has the highest packet filter rule hit count from the set of PDU sessions.
